(19) United States
(12) Patent Application Publication
(10) Pub. No.: US 2004/0237110 A1
(43) Pub. Date: Nov. 25, 2004

(54) Display monitor

(76) Inventor: Morris E. Jones JR., Saratoga, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/444,152

(22) Filed: May 21, 2003

(51) Int. Cl. H04N 7/173; H04N 7/18

(52) U.S. Cl. 725/74; 725/80; 725/109; 725/110

(57) ABSTRACT

Described is a display monitor comprising a receiver to receive compressed graphics data and a graphics decompression device to provide decompressed graphics data based upon the compressed graphics data. A display device may then generate an image in response to the decompressed graphics data.

### BACKGROUND

1. Field

The subject matter disclosed herein relates to display monitors. In particular, the subject matter disclosed herein relates to display monitors capable of generating an image in response to graphics data.

2. Information

A personal computer system typically includes a display monitor which is capable of generating a visual image in response to graphics data generated by a graphics or video controller in a host computer system. The graphics or video controller typically provides graphics data to a frame buffer in a display interface. In response to the graphics data loaded to the frame buffer, the display interface typically transmits display signals to a display device in any one of several display signal formats such as Digital Video Interface (DVI) or Video Graphics Array (VGA) signaling formats.

Devices in a data network are typically coupled to one another by a data transmission medium. In a local area network (LAN), for example, devices are typically coupled together by Ethernet data links capable of transmitting data frames in any one of several Ethernet compatible transmission media such as unshielded twisted wire pair cabling. Graphics data is typically transmitted to a client device (e.g., personal computer system) on a LAN for display on a display monitor at the client device. Since raw graphics data used to generate video images is typically voluminous, graphics data is typically compressed prior to transmission on Ethernet data links which have limited data transmission capacity. Techniques to compress video data prior to transmission may include any one of several graphics compression techniques to transform the graphics data into compressed graphics data which may be transmitted using lower speed data links. Such graphics compression techniques may include versions of MPEG or JPEG. Using MPEG compression, for example, graphics data to represent temporally adjacent video frames to be displayed in sequence is typically combined by indicating the differences in encoded graphics values between the adjacent video frames.

The data transmission medium used to transmit data in an Ethernet data link (e.g., unshielded twisted wire pair cabling) has been used to transmit power to a device coupled to the data transmission medium at a media dependent interface (e.g., RJ-45 coupling). A standard for such power transmission over an Ethernet data link is being defined by the IEEE 802.3af task force.

### BRIEF DESCRIPTION OF THE FIGURES

Non-limiting and non-exhaustive embodiments of the present invention will be described with reference to the following figures, wherein like reference numerals refer to like parts throughout the various figures unless otherwise specified.

FIG. 1 shows a system to transmit compressed graphics data in a data network according to an embodiment of the present invention.

FIG. 2 shows a host computer system according to an embodiment of the system shown in FIG. 1.

FIG. 3 shows a display monitor according to an embodiment of the system shown in FIG. 1.

### DETAILED DESCRIPTION

Reference throughout this specification to “one embodiment” or “an embodiment” means that a particular feature, structure, or characteristic described in connection with the embodiment is included in at least one embodiment of the present invention. Thus, the appearances of the phrase “in one embodiment” or “an embodiment” in various places throughout this specification are not necessarily all referring to the same embodiment. Furthermore, the particular features, structures, or characteristics may be combined in one or more embodiments.

“Machine-readable” instructions as referred to herein relates to expressions which may be understood by one or more machines for performing one or more logical operations. For example, machine-readable instructions may comprise instructions which are interpretable by a processor compiler for executing one or more operations on one or more data objects. However, this is merely an example of machine-readable instructions and embodiments of the present invention are not limited in this respect.

“Storage medium” as referred to herein relates to media capable of maintaining expressions which are perceivable by one or more machines. For example, a storage medium may comprise one or more storage devices for storing machine-readable instructions or data. Such storage devices may comprise storage media such as, for example, optical, magnetic or semiconductor storage media. However, these are merely examples of a storage medium and embodiments of the present invention are not limited in these respects.

“Logic” as referred to herein relates to structure for performing one or more logical operations. For example, logic may comprise circuitry which provides one or more output signals based upon one or more input signals. Such circuitry may comprise a finite state machine which receives a digital input and provides a digital output, or circuitry which provides one or more analog output signals in response to one or more analog input signals. Such circuitry may be provided in an application specific integrated circuit (ASIC) or field programmable gate array (FPGA). Also, logic may comprise machine-readable instructions stored in a storage medium in combination with processing circuitry to execute such machine-readable instructions. However, these are merely examples of structures which may provide logic and embodiments of the present invention are not limited in these respects.

“Graphics data” as referred to herein relates to data that is representative of an image or a portion of an image. For example, graphics data may comprise pixel values in an image which are used to indicate a luminance or chrominance value to be associated with pixels. However, this is merely an example of graphics data and embodiments of the present invention are not limited in these respects.

Graphics data may comprise data bits that can be stored in a storage medium or transmitted in a data transmission medium. “Compressed graphics data” as referred to herein relates to graphics data that is transformed to reduce an amount of data to represent all or a portion of an image. In some examples, graphics data may be compressed by transforming the graphics data to indicate differences between spatially distinct graphics primitives (e.g., differences between spatially distinct portions of a video frame) or indicate differences between temporally distinct graphics primitives (e.g., differences between temporally adjacent video frames) as used in versions of MPEG or JPEG graphics compression techniques. In other examples, graphics data may be compressed using any one of several “numerical” or “lossless” data compression techniques to compress the graphics data independently of the use of representing distinctions between graphics primitives (“numerical” and “lossless” compression to be used hereinafter interchangeably). Such a numerical or lossless data compression techniques may be used to independently compress data representing individual pixels or portions of an image using any one several data compression formats such as, for example, adaptive Huffman, run-length encoding or adaptive pulse code modulation compression formats. However, these are merely examples of how graphics data may be compressed using numerical or lossless compression techniques and embodiments of the present invention are not limited in these respects.

A “display monitor” as referred to herein relates to an apparatus that is capable of displaying an image. A display monitor may comprise an enclosure and one or more connectors to receive a power signal and graphics data. A display monitor may also comprise a “display device” which is capable of displaying an image in response to display signals provided in a display signaling format. However, these are merely examples of a display device and a display monitor, and embodiments of the present invention are not limited in these respects.

A “data frame” as referred to herein relates to a segment of data which is formatted for transmission from a source to a destination. A data frame may comprise a header portion and a payload portion. According to any particular data transmission protocol, a data frame may be defined as having a fixed length or variable length. However, these are merely examples of a data frame and embodiments of the present invention are not limited in these respects.

An “Ethernet frame” as referred to herein relates a data frame that is formatted for transmission in a data link according to any one of several data transmission protocols defined in IEEE Std. 802.3. For example, an Ethernet frame may comprise a data field to identify an address of a media access controller (MAC) associated with a destination for the Ethernet frame. However, this is merely an example of an Ethernet frame and embodiments of the present invention are not limited in this respect.

“Ethernet transmitter” as referred to herein relates to a device that is capable of transmitting Ethernet frames in any one of several types of data transmission mediums. For example, an Ethernet transmitter may comprise a MAC or a physical layer data transmission device that is capable of transmitting an Ethernet frame according to any one of several Ethernet data transmission protocols. An “Ethernet receiver” as referred to herein relates to a device that is capable of receiving Ethernet frames in any one of several types of data transmission mediums. For example, an Ethernet receiver may comprise a MAC or a physical layer data transmission device that is capable of receiving an Ethernet frame according to any one of several Ethernet data transmission protocols.

A “packet switch” as referred to herein relates to a device that is capable of forwarding data packets received from a source device to a destination device. For example, a packet switch may comprise one or more ingress ports for receiving data packets from source devices and one or more egress ports for transmitting the received data packets to destination devices. The packet switch may select an egress port for transmitting a received data packet based upon destination information in the data packet and according to a data network protocol. However, this is merely an example of a packet switch and embodiments of the present invention are not limited in this respect.

Briefly, an embodiment of the present invention relates to a display monitor comprising a receiver to receive compressed graphics data and a graphics decompression device to provide decompressed graphics data based upon the compressed graphics data. A display device may then generate an image in response to the decompressed graphics data. However, this is merely an example embodiment and embodiments of the present invention are not limited in these respects.

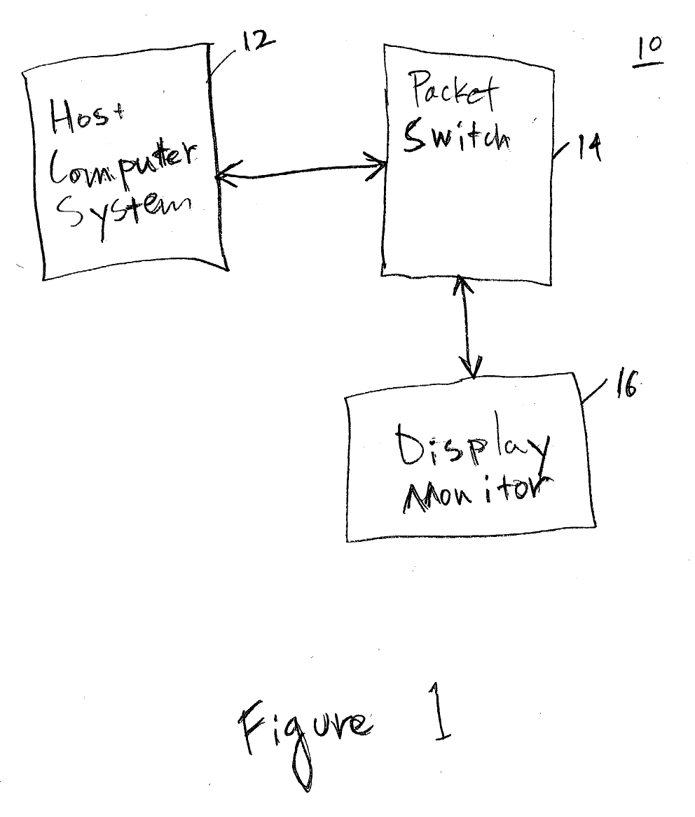

FIG. 1 shows a system 10 to transmit compressed graphics data in a data network according to an embodiment of the present invention. A host computer system 12 comprises a network interface controller (NIC, not shown) to transmit data frames to a display monitor 16. According to an embodiment, the data frames may comprise address information identifying the display monitor as a destination for the data frames. Accordingly, a packet switch 14 may forward data packets in data frames received from the host computer system 12 to the display monitor based upon the address information. The display monitor 16 may display an image based upon graphics data in data packets frames received from the host processing system 12.

According to an embodiment, the packet switch 14 may comprise a plurality of ingress and egress ports (not shown) to forward data packets from a source to a destination where the host computer system 12 and display monitor 16 are each coupled to a corresponding port. The data frames may comprise data packets that are formatted according to a network protocol such as, for example, an in Internet Protocol (IP). Such IP packets may comprise a header portion and a payload portion where the header portion comprises a destination address identifying the display monitor as a network destination. Accordingly, the packet switch 14 may route data packets received from the host computer system 12 to the display monitor 16 based upon the destination address in the data packets. The display monitor 16 may de-encapsulate the payload portion comprising compressed graphics data to be processed at the display monitor 16.

In addition to a destination address, the data packets may comprise session layer information for processing compressed graphics data according to a session layer protocol such as the Transmission Control Protocol (TCP) or User Datagram Protocol (UDP) session layer protocols. However, these are merely examples of session layer protocols and embodiments of the present invention are not limited in these respects.

According to an embodiment, data frames transmitted from the host processing system 12 and received at the display monitor 16 may comprise graphics data which is compressed according to any one of several compression formats. In some embodiments, the compressed graphics data may be compressed in a compression format which represents uncompressed graphics data by indicating differences between graphics primitives as used in MPEG or JPEG compression techniques. In other embodiments, the graphics data may be compressed in a numerical or lossless data compression format that does not rely on indications of differences between graphics primitives.

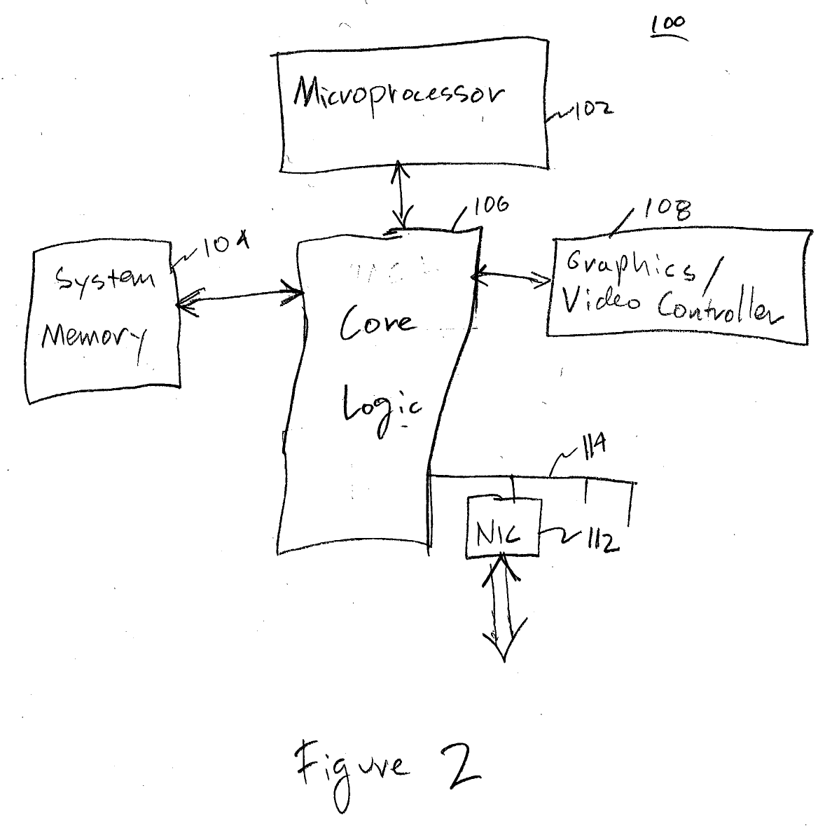

FIG. 2 shows a host computer system 100 according to an embodiment of the host computer system 12 shown in FIG. 1. The host computer system 100 may comprise a microprocessor 102, system memory 104, a graphics/video controller 108 and one or more peripheral devices coupled to a data bus 114. Core logic 106 may enable communication among the components in the host computer system 100 and comprise a memory controller hub (MCH) (not shown) and input/output controller hub (ICH) (not shown) sold by Intel Corporation. The microprocessor 102 may comprise any one of several commercially available microprocessors such as the Pentium®, Xeon® or Celeron® brand processors sold by Intel Corporation. However, these are merely example microprocessors and other microprocessors may be used.

The data bus 114 may comprise a multiplex data bus formed according to the Peripheral Components Interconnect (PCI) Local Bus Specification, Rev. 2.3. A NIC 112 may comprise a physical layer data transceiver adapted to be coupled to a data transmission medium and a MAC device coupled to the data bus 114. According to an embodiment, the NIC 112 may comprise an Ethernet transmitter to transmit data packets stored in predefined locations of system memory 104 to the data transmission medium according to any one of several Ethernet protocols defined in IEEE Std. 802.3-2000. In an alternative embodiment, the NIC 112 may comprise a wireless networking transmitter to transmit the data packets from the system memory 104 according to any one of several wireless networking protocols such as, for example, wireless networking protocols defined in versions of IEEE Std. 802.11. However, these are merely examples of protocols that may be used by a NIC to transmit data and embodiments of the present invention are not limited in these respects.

While the graphics/video controller, data bus 114 and NIC 112 are shown as distinct elements of the host computer system 100, it should be understood that one or more of these elements may comprise an add in card that is coupled to the core logic 106 or, alternatively, may be integrated with one or more devices of the core logic 106. However, these are merely examples of how a graphics/video controller, NIC or data bus may be integrated with a host computer system, and embodiments of the present invention are not limited in these respects.

According to an embodiment, the graphics/video controller 108 may generate graphics data in response to inputs from an operating system hosted on the host computer system 100. In one embodiment, the graphics/video controller 108 may be coupled to the core logic 106 by an Advanced Graphics Port (not shown). Upon generating graphics data, the graphics/video controller 108 may compress the graphics data according to any one of the aforementioned data compression formats and transmit) the compressed graphics data to the NIC 112 using direct memory access (DMA) techniques known to those of ordinary skill in the art. The NIC 112 may then initiate transmission of the compressed graphics data in data packets. Alternatively, an application executed by the microprocessor 102 may receive uncompressed graphics data from the graphics/video controller 108 at a predetermined location in system memory 104. The application may then compress the graphics data using any one of the aforementioned compression techniques, and initiate transmission of the compressed graphics data in data packets through the NIC 112. Alternatively, the graphics data may store in a frame buffer contained within the graphics/video controller 108 or contained within the system memory 104 (e.g., which may be accessed by the graphics/video controller for display). The graphics data may then be compressed and transmitted in data packets.

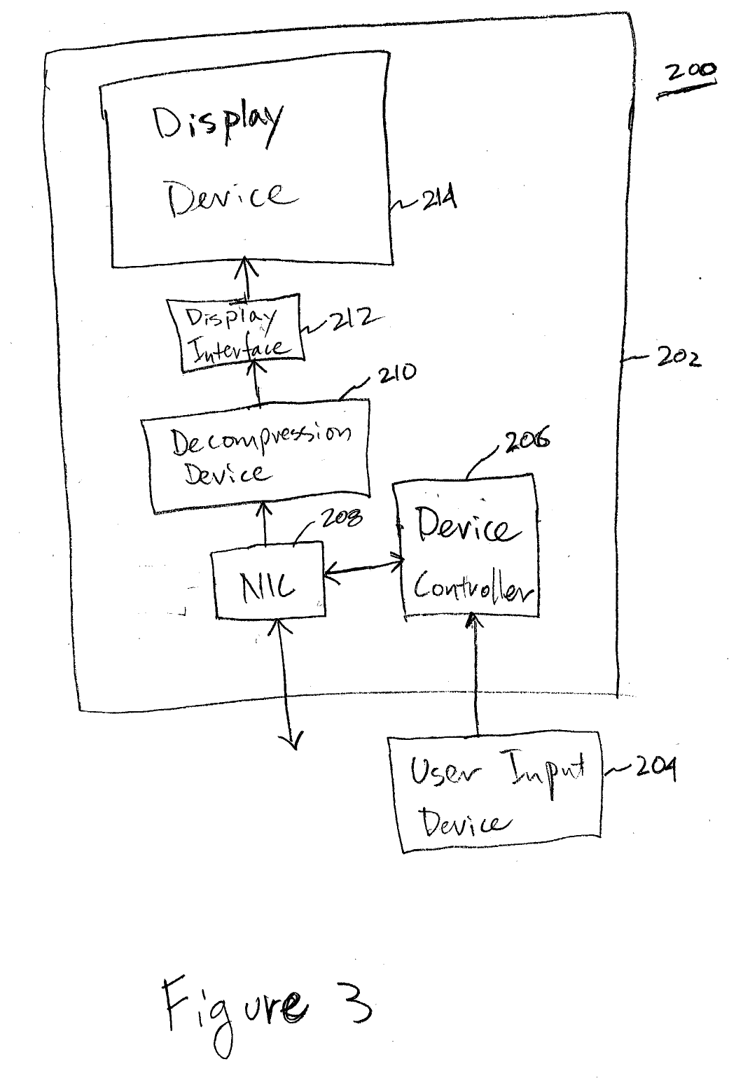

FIG. 3 shows a display monitor 200 according to an embodiment of the system 10 shown in FIG. 1. Disposed within an enclosure 202, the display monitor 200 may comprise display device 214 to generate an image in response to signals received at a display interface 212, a NIC 208 to receive data frames from a data transmission medium, and a decompression device 212 to provide decompressed graphics data to the display interface 212 in response to compressed graphics data received from the NIC 208.

The NIC 208 may comprise a physical layer data transceiver adapted to be coupled to a data transmission medium and MAC device coupled to the decompression device 210. According to an embodiment, the NIC 208 may comprise an Ethernet receiver to receive data packets in a receive buffer (not shown) from the data transmission medium according to any one of several Ethernet protocols defined in IEEE Std. 802.3-2000. For example, the NIC 208 may receive the data packets in Ethernet frames forwarded to the display monitor from the packet switch 14 (FIG. 1). In an alternative embodiment, the NIC 208 may comprise a wireless networking receiver to receive the data packets from the system memory 104 according to any one of several wireless networking protocols such as, for example, wireless networking protocols defined in versions of IEEE Std. 802.11. However, these are merely examples of protocols that may be used by a NIC to receive data and embodiments of the present invention are not limited in these respects.

According to an embodiment, the display device 214 may comprise any type of display device capable of generating an image in response to display signals. For example, the display device 214 may comprise a cathode ray tube (CRT) or a liquid crystal display device (LCD). However, these are merely examples of a display device capable of generating an image in response to display signals and embodiments of the present invention are not limited in these respects.

The NIC 208 may be coupled to the decompression device 210 by a data bus (not shown) to forward received data packets from the receive buffer to the decompression device 210 in a pipelined fashion. As described above, the data packets received from the host computer system 12 may contain compressed graphics data. According to an embodiment, the decompression device 210 comprises logic to decompress the compressed graphics data to provide data to the display interface 212. In one embodiment, the display interface 212 may comprise a video buffer (not shown) to receive the decompressed graphics data and provide display signals to the display device 214 for generating an image. The display interface 212 may provide the display signals to the display device 214 according to any one of several display signaling formats such as, for example, Digital Video Interface (DVI) or Video Graphics Array (VGA) signaling formats. However, these are merely examples of display signaling formats that may be used for generating an image on a display device and embodiments of the present invention are not limited in these respects.

According to an embodiment, the compressed graphics data may be received at the NIC 208 in any one of several compression formats. In some embodiments, the compressed graphics data may be compressed in a compression format which represents uncompressed graphics data by indicating distinctions between graphics primitives as used in MPEG or JPEG compression formats. In this embodiment, the video buffer of the display interface 212 may comprise a video frame buffer (e.g., 3 MB) to receive video frames from the decompression device 210 on a refresh cycle. Accordingly, the decompression device may operate on the compressed graphics data according to predetermined algorithms to reconstruct graphics data representing a sequence of video frames to be loaded in sequence to the video frame buffer on refresh cycles.

In other embodiments, the compressed graphics data may be received at the NIC 208 in a numerical or lossless data compression format independent of representations of distinctions between graphics primitives. Such a numerical or lossless data compression format may represent data of individual pixels or groups of pixels in any one of several data compression formats such as, for example, adaptive Huffman, run-length encoding or adaptive pulse code modulation compression formats. However, these are merely examples of data compression techniques that may be used for numerical or lossless graphics data compression, and other data compression techniques may be used.

Using a numerical or lossless decompression scheme, discrete portions of the compressed graphics data may uniquely represent corresponding discrete portions of the image to be reconstructed. In one example, data for each pixel in a video frame (e.g., eight bits used for representing an intensity of each of three hues such as red, green and blue) may be compressed and decompressed independently of data to represent other pixels in the same or different video frame. Similarly, data for groups of adjacent groups of pixels in a video line may be compressed and decompressed independently of data to represent other groups of pixels in the same video line.

With graphics data compressed in such a numerical or lossless compression format, the decompression device 210 may reconstruct fractional portions of video frames such as video lines or partial video lines independently of compressed graphics data used to represent an entire video frames or temporally adjacent video frames. The video buffer of the video interface 212 may then be sized to receive data for a fractional frame such as a line buffer or partial line buffer. Accordingly, instead of receiving entire video frame of decompressed graphics data on refresh cycles, the video buffer may continuously receive graphics data to represent partial video frames (e.g., video lines or partial video lines).

It some embodiments, it may be desired to display an image on the display device 214 in real-time such that an image represented by graphics data generated at the host computer system 12 (e.g., by the graphics/video controller 108) is displayed contemporaneously on the display device 214. Thus, using a substantially high data rate connection to the NIC 208 (e.g., 100Base-TX connection or higher data rate connection), graphics data compressed according to one of the aforementioned numerical or lossless compression techniques may be used to generate an image on the display device 214. Accordingly, the computationally intensive process of reconstructing an image from other compression techniques that rely on the spatial differences between graphics primitives in the same video frame or differences between graphics primitives in temporally adjacent video frames (e.g., MPEG) can be avoided.

According to an embodiment, the NIC 208 may be coupled to an unshielded twisted wire pair cable (e.g., category 5 cabling) by a connection such as an RJ-45 connection. As such, using techniques known to those of ordinary skill in the art, the components of the display monitor 200 may be powered through a current drawn from two or more of the wires in the cable. Using an Ethernet connection, for example, such techniques for powering a device coupled to a cable may be as proposed by the IEEE 802.3af task force. Here, any one or a combination of these devices (e.g., the display device 214, display interface 212, decompression device 210 or NIC 208) may be characterized as having a load to receive the current for powering the display monitor 200. Accordingly, the device combination of devices may be powered only by the current drawn from the wires in the cable without the use of an additional power source.

While the NIC 208 comprises a data receiver to receive data packets containing compressed graphics data (for use in generating an image on display device 214), the NIC 208 may also comprise a data transmitter to transmit data packets containing user inputs to the host computer system 12 (FIG. 1). The display monitor 200 may comprise a device controller 206 to receive user inputs from a user input device 204 attachable to the display monitor 200 at a port (not shown). The user input device 204 may comprise any one or combination of input devices such as, for example, a mouse, keyboard, joy stick, etc. The device controller 206 may comprise logic to packetize user input commands from the user input device 204 for transmission to the host computer system 12 (e.g., through the packet switch 14 using any of the aforementioned network protocols). In other embodiments, the device controller 206 may comprise a universal serial bus (USB) controller to receive inputs from USB input devices. In addition to USB input devices, the device controller 206 may also be coupled to and external data storage drive (not shown) that may be used as an auxiliary storage device for the host computer system 12.

According to an embodiment, an enterprise may comprise several host computer systems that may be coupled to the display monitor 200 over a data network (e.g., through the packet switch 14) where a particular host computer system may be associated with a particular user. The display monitor 200 may comprise security logic (e.g., in a SIM card) enabling the user to access the associated host computer system through the data network while denying unauthorized users from such access. For example, a user may gain access to the host computer system by inserting an encoded security key (e.g., with a magnetic storage medium, not shown) into a slot on the display monitor 200. The security logic may authenticate the user from information on the security key and begin receiving compressed graphics data from the host computer system for display and transmitting user inputs from the device controller 206.

While there has been illustrated and described what are presently considered to be example embodiments of the present invention, it will be understood by those skilled in the art that various other modifications may be made, and equivalents may be substituted, without departing from the true scope of the invention. Additionally, many modifications may be made to adapt a particular situation to the teachings of the present invention without departing from the central inventive concept described herein. Therefore, it is intended that the present invention not be limited to the particular embodiments disclosed, but that the invention include all embodiments falling within the scope of the appended claims.

What is claimed is:

1. A system comprising:
a packet switch to forward data packets from a source to a destination;
a host computer system comprising an Ethernet transmitter to transmit compressed graphics data to the packet switch in Ethernet frames; and
a display monitor comprising:
an Ethernet receiver to receive the compressed graphics data from the packet switch;
a graphics decompression device to provide decompressed graphics data based upon the compressed graphics data; and
a display device to display an image in response to the decompressed graphics data.

2. The system of claim 1, wherein the packet switch comprises logic to forward the data packets according to an Internet Protocol.

3. The system of claim 1, wherein the graphics decompression device comprises logic to de-encapsulate the compressed graphics data from IP packets.

4. The system of claim 1, wherein the compressed graphics data is compressed according to a lossless data compression format.

5. The system of claim 4, wherein the lossless compression format comprises one of an adaptive Huffman, run length encoding and adaptive pulse code modulation compression formats.

6. The system of claim 1, the display monitor further comprising a display interface to receive the decompressed graphics data in a video buffer, and generate display signals according to a display signaling format.

7. The system of claim 6, wherein the display signaling format comprises one of a digital video interface format and a video graphics array format.

8. The system of claim 6, wherein the video buffer comprises a video frame buffer to receive frame data on a frame refresh cycle.

9. The system of claim 6, wherein the video buffer comprises a partial frame buffer to receive data representative of a fraction of a data frame.

10. The system of claim 9, wherein the partial frame buffer comprises a video line buffer to receive data representative of a video line.

11. The system of claim 9, wherein the partial frame buffer comprises a partial video line buffer to receive data representative of a partial video line.

12. The system of claim 1, wherein the display monitor further comprises:
an Ethernet adapter adapted to transmit data to the host computer system, the Ethernet adapter comprising the Ethernet receiver and an Ethernet transmitter; and
a device controller adapted to being coupled to a device external to the display monitor and capable of at least one of transmitting data to and receiving data from the host computer system through the Ethernet adapter.

13. The system of claim 12, wherein the device controller is adapted to being coupled to one or more external universal serial bus devices.

14. The system of claim 13, wherein the external device comprises a user input device and the device controller comprises logic to transmit data to the host processing system in response to inputs from the user input device.

15. The system of claim 13, wherein the external device comprises a data storage device.

16. The system of claim 1, wherein the Ethernet receiver is adapted to receive the compressed graphics data from a data transmission medium, and wherein at least one of the display device and the decompression device comprise a load to draw a current from the data transmission medium.

17. A display monitor comprising:
an Ethernet receiver to receive compressed graphics data;
a graphics decompression device to provide decompressed graphics data based upon the compressed graphics data; and
a display device to display an image in response to the decompressed graphics data.

18. The display monitor of claim 17, wherein the graphics decompression device comprises logic to de-encapsulate the compressed graphics data from IP packets.

19. The display monitor of claim 17, wherein the compressed graphics data is compressed according to a lossless data compression format.

20. The display monitor of claim 19, wherein the lossless compression format comprises one of an adaptive Huffman, run length encoding and adaptive pulse code modulation compression formats.

21. The display monitor of claim 17, the display monitor further comprising a display interface to receive the decompressed graphics data in a video buffer, and generate display signals according to a display signaling format.

22. The display monitor of claim 21, wherein the display signaling format comprises one of a digital video interface format and a video graphics array format.

23. The display monitor of claim 21, wherein the video buffer comprises a video frame buffer to receive frame data on a frame refresh cycle.

24. The display monitor of claim 21, wherein the video buffer comprises a partial frame buffer to receive data representative of a fraction of a data frame.

25. The display monitor of claim 24, wherein the partial frame buffer comprises a video line buffer to receive data representative of a video line.

26. The display monitor of claim 25, wherein the partial frame buffer comprises a partial video line buffer to receive data representative of a partial video line.

27. The display monitor of claim 17, wherein the display monitor further comprises:
an Ethernet adapter adapted to transmit data to the host computer system, the Ethernet adapter comprising the Ethernet receiver and an Ethernet transmitter; and
a device controller adapted to being coupled to a device external to the display monitor and capable of at least one of transmitting data to and receiving data from the host computer system through the Ethernet adapter.

28. The display monitor of claim 27, wherein the device controller is adapted to being coupled to one or more external universal serial bus devices.

29. The display monitor of claim 27, wherein the external device comprises a user input device and the device controller comprises logic to transmit data to the host processing system in response to inputs from the user input device.

30. The display monitor of claim 29, wherein the external device comprises a data storage device.

31. The display monitor of claim 17, wherein the Ethernet receiver is adapted to receive the compressed graphics data from a data transmission medium, and wherein at least one of the display device and the decompression device comprise a load to draw a current from the data transmission medium.

32. A method comprising:
compressing graphics data at a host computer system to provide compressed graphics data;
transmitting the compressed graphics data through a packet switch to a display monitor comprising an Ethernet receiver;
receiving compressed graphics data at the Ethernet receiver;
decompressing the received compressed graphics to provide decompressed graphics data; and
displaying an image in response to the decompressed graphics data.

33. The method of claim 32, the method further comprising de-encapsulating the received compressed graphics data from IP packets.

34. The method of claim 32, the method further comprising compressing the graphics data according to a Huffman compression scheme.

35. The method of claim 32, the method further comprising:
receiving the decompressed graphics data in a frame buffer; and
generating display signals according to a display signaling format.

36. The method of claim 35, the method further comprising generating the display signals in one of a digital video interface format and a video graphics array format.

37. The method of claim 32, wherein the display monitor further comprises a device controller and an Ethernet adapter adapted to transmit data to the host computer system, the Ethernet adapter comprising the Ethernet receiver and an Ethernet transmitter, the method further comprising transmitting data to the host computer system from the device controller through the Ethernet adapter.

38. The method of claim 37, wherein the device controller is adapted to being coupled to one or more external universal serial bus devices.

39. The method of claim 38, wherein the external device comprises a user input device and the method further comprises transmitting data to the host processing system in response to inputs from the user input device.

40. The method of claim 38, the method further comprising coupling the device controller to a data storage device.

41. The method of claim 32, wherein the Ethernet receiver is adapted to receive the compressed graphics data from a data transmission medium, and wherein at least one of the display device and the decompression device comprise a load, the method further comprising applying a current from the data transmission medium to the load.

42. A system comprising:
a packet switch to forward data packets from a source to a destination;
a host computer system comprising:
logic to compress graphics data according to a lossless data compression format.
a first network interface controller (NIC) to transmit the compressed graphics data to the packet switch in data frames; and
a display monitor comprising:
a second NIC to receive the compressed graphics data from the packet switch;
a graphics decompression device to provide decompressed graphics data based upon the compressed graphics data; and
a display device to display an image in response to the decompressed graphics data.

43. The system of claim 42, wherein the lossless compression format comprises one of adaptive Huffman, run length encoding and adaptive pulse code modulation compression formats.

44. The system of claim 42, wherein the second NIC is capable of receiving the compressed graphics data according to an Ethernet data transmission protocol.

45. The system of claim 42, wherein the second NIC is capable of receiving the compressed graphics data according to a wireless networking protocol.

46. A display monitor comprising:
a network interface controller (NIC) to receive compressed graphics data;
a graphics decompression device to provide decompressed graphics data based upon the compressed graphics data, the graphics decompression device comprising logic to generate the decompressed graphics data from graphics data compressed according to a lossless compression format; and
a display device to display an image in response to the decompressed graphics data.

47. The display monitor of claim 46, wherein the lossless compression format comprises one of adaptive Huffman, run length encoding and adaptive pulse code modulation compression formats.

48. The display monitor of claim 46, wherein the second NIC is capable of receiving the compressed graphics data according to an Ethernet data transmission protocol.

49. The display monitor of claim 46, wherein the second NIC is capable of receiving the compressed graphics data according to a wireless networking protocol.
